(19) United States
(12) Patent Application Publication
(10) Pub. No.: US 2025/0080570 A1
(43) Pub. Date: Mar. 6, 2025

(54) SYSTEM AND METHOD FOR MANAGEMENT OF OFF-NETWORK REMOTE ACCESS TO PREVENT UNAUTHORIZED ACCESS TO SENSITIVE DATA

(71) Applicant: BANK OF AMERICA CORPORATION, Charlotte, NC (US)

(72) Inventors: Charlene Ramsue, Statesville, NC (US); Angela Easter Cooke, Cana, VA (US); Brian Corr, Gilbert, AZ (US); Thomas Gail Frost, JR., Gilbert, AZ (US); Michelle Lee Keas, Phoenix, AZ (US); Youshika Scott, Charlotte, NC (US); Bonnie B. Sithideth, Jacksonville, FL (US); Terri Smith Wright, Mooresville, NC (US); Brandalyn A. Yetter, Chesapeake, VA (US)

(73) Assignee: BANK OF AMERICA CORPORATION, Charlotte, NC (US)

(21) Appl. No.: 18/242,969

(22) Filed: Sep. 6, 2023

(51) Int. Cl. H04L 9/40

(52) U.S. Cl. CPC H04L 63/1441; H04L 63/102; H04L 63/1416

(57) ABSTRACT

Systems, computer program products, and methods are described herein for management of off-network remote access to prevent unauthorized access to sensitive data. The present disclosure is configured to receive an off-network remote access login associated with a user within a network; compare the off-network remote access login against a set of previous off-network remote access logins within a user action database using an advanced computational model for data analysis and automated decision-making; determine whether the login constitutes suspicious activity; trigger a set of remedial actions if the off-network remote access login constitutes suspicious activity; and incorporate the off-network remote access into the user action database.

### TECHNOLOGICAL FIELD

Example embodiments of the present disclosure relate to systems and methods for management of off-network remote access to prevent unauthorized access to sensitive data.

### BACKGROUND

Off-network remote access to an entity has provided access to data and the capability to view/manipulate the data within said entity with less security may be employed with non-remote access.

Applicant has identified a number of deficiencies and problems associated with off-network remote access management platforms. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for system and methods for management of off-network remote access to prevent unauthorized access to sensitive data.

In one aspect, a system for management of off-network remote access to prevent unauthorized access to sensitive data is provided. The system includes at least one non-transitory storage device and at least one processing device coupled to the at least one non-transitory storage device. The at least one processing device is configured to cause the at least one processing device to perform the following operations: receive an off-network remote access login associated with a user within a network; compare the off-network remote access login against a set of previous off-network remote access logins associated with the user using an advanced computational model for data analysis and automated decision-making, wherein the set of previous off-network remote access logins associated with the user are stored within a user action database; determine whether the off-network remote access login constitutes suspicious activity based on the comparison to the set of previous off-network remote access logins associated with the user within the user action database through the advanced computational model for data analysis and automated decision making; incorporate the off-network remote access login associated with the user into the user action database; and trigger a set of remedial actions if the off-network remote access login constitutes suspicious activity.

In some embodiments, suspicious activity is defined by a set of predetermined criteria within the user action database.

In some embodiments, the set of predetermined criteria comprises the off-network remote access login occurring during a set of predetermined hours.

In some embodiments, the set of remedial actions comprises transmission of a customizable notification to a third party.

In some embodiments, the set of remedial actions comprises transmission of a push notification to an end-point device to enable the off-network remote access login.

In some embodiments, the push notification is transmitted to an end-point device during a set of predetermined notification login hours.

In some embodiments, wherein a set of systems within the network are restricted for off-network remote access logins constituted as suspicious activity.

In another aspect, a computer program product for management of off-network remote access to sensitive data is provided. The computer program product comprising at least one non-transitory computer-readable medium having computer-readable program code portions embodied therein, the computer-readable program code portions comprising: an executable portion configured to receive an off-network remote access login associated with a user within a network; an executable portion configured to compare the off-network remote access login against a set of previous logins associated with the user using an advanced computational model for data analysis and automated decision-making, wherein the set of previous off-network remote access logins associated with the user are stored within a user action database; an executable portion configured to determine whether the off-network remote access login constitutes suspicious activity based on the comparison to the set of previous off-network remote access logins associated with the user within the user action database through the advanced computational model for data analysis and automated decision-making; an executable portion configured to incorporate the off-network remote access login associated with the user into the user action database; and an executable portion configured trigger a set of remedial actions if the off-network remote access login constitutes suspicious activity.

In some embodiments, suspicious activity is defined by a set of predetermined criteria within the user action database.

In some embodiments, the set of predetermined criteria comprises the off-network remote access login occurring during a set of predetermined hours.

In some embodiments, the set of remedial actions comprises transmission of a customizable notification to a third party.

In some embodiments, the set of remedial actions comprises transmission of a push notification to an end-point device to enable the off-network remote access login.

In some embodiments, the push notification is transmitted to an end-point device during a set of predetermined notification login hours.

In some embodiments, wherein a set of systems within the network are restricted for off-network remote access logins constituted as suspicious activity.

In another aspect, a method for management of off-network remote access to prevent unauthorized access to sensitive data is provided. In some embodiments, the computer-implemented method comprises: receiving an off-network remote access login associated with a user within a network; comparing the off-network remote access login against a set of previous off-network remote access logins associated with the user using an advanced computational model for data analysis and automated decision-making, wherein the set of previous off-network remote access logins associated with the user are stored within a user action database; determining whether the off-network remote access login constitutes suspicious activity based on the comparison to the set of previous off-network remote access logins within the user action database through the advanced computational model for data analysis and automated decision making; incorporating the off-network remote access login associated with the user into the user action database; and triggering a set of remedial actions if the off-network remote access login constitutes suspicious activity.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for management of off-network remote access to prevent unauthorized access to sensitive data in accordance with an embodiment of the disclosure.

FIG. 2 illustrates an exemplary machine learning (MIL) subsystem architecture, in accordance with an embodiment of the disclosure; and

FIG. 3 illustrates a process flow for management of off-network remote access to prevent unauthorized access to sensitive data in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Access to sensitive data within a remote workspace (i.e., off-network remote access) has enabled users within an entity to view, manipulate, and work outside of traditional working hours and locations (i.e., outside of an office or established workplace). While off-network remote access has expanded the freedom of users to work at a time and location preferred by said users, remote access has created security concerns within the entity an possible sensitive data within said entity.

Off-network remote access has created security concerns associated with said sensitive data, including but not limited to the unauthorized viewing, manipulation, or further malicious activity associated with the sensitive data. While off-network remote access may continue to be utilized within an entity or organization, sensitive data may face increased exposure from users and be subjected to suspicious actions. Mitigation and monitoring of suspicious activity and the exposure of the sensitive data may enhance the security of the entity overall through regulation of off-network remote access logins.

Detection, prevention, and notification regarding suspicious activity may be performed/assisted at least partially with machine learning, or an advanced computational model for data analysis and automated decision-making. When an off-network remote access login is received, the login attempt is compared to previous logins associated with the user, then analyzed by machine learning to determine if the off-network remote login qualifies as suspicious activity. Suspicious activity may be detected through comparison of the off-network remote access logins to previous logins associated with the user, as well as internal policies and procedures within the entity. If suspicious activity is detected, a series of remedial actions may be implemented such as transmission of notifications, restriction of abilities/access for the user, and/or denial of the off-network remote access login.

Accordingly, the present disclosure comprises using machine learning (advanced computational models for automated decision-making) to analyze and evaluate off-network remote access logins (remote work logins). The off-network remote access login (and the activity associated with the user while logged in) may be analyzed based on previous logins and actions associated with the user to determine if the login constitutes suspicious activity (i.e., if the login occurs at an unusual time, through a new device, at a new location, etc.,). If suspicious activity is detected, remedial actions may be implemented to further detect, prevent, and deter unauthorized access to sensitive data. Remedial actions may be comprised of transmission of a customizable notification (i.e., the message of the notification, the recipients of the transmitted message, the time in which the message is transmitted may be customizable), transmission of a push notification, and/or at least partial restrictions on system capabilities upon detection of suspicious activity.

What is more, the present disclosure provides a technical solution to a technical problem. As described herein, the technical problem includes management of off-network remote access to prevent unauthorized access to sensitive data. The technical solution presented herein allows for off-network remote access logins to be assessed by forms of machine learning to determine if the login constitutes suspicious activity, then implementing remedial actions to address the suspicious activity if discovered. In particular, management and remedial actions implemented to mitigate and prevent suspicious activity are an improvement over existing solutions to the management of off-network remote access to prevent unauthorized access to sensitive data, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

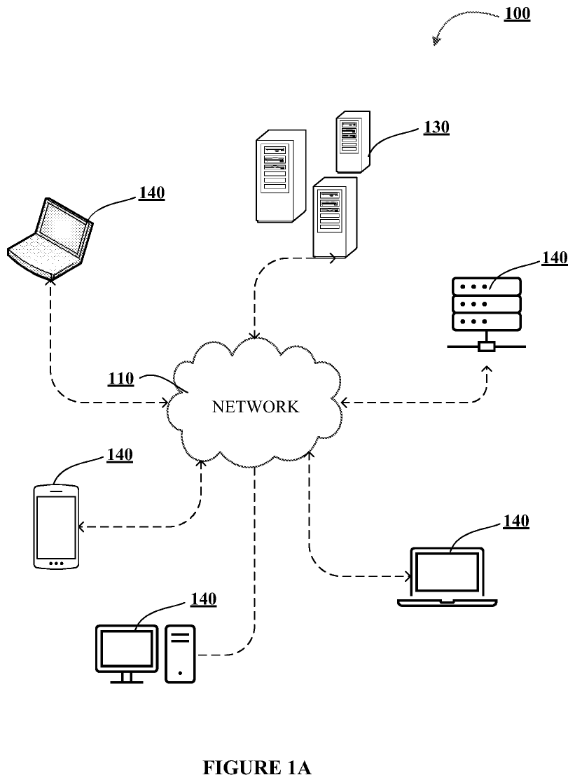

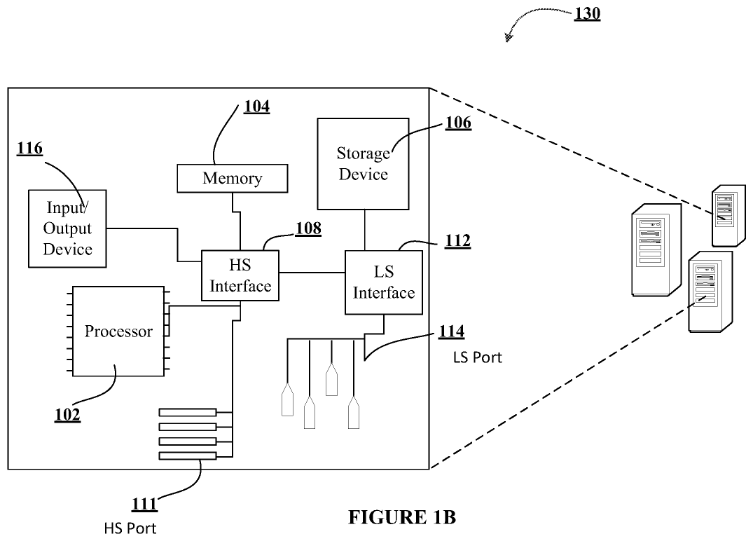

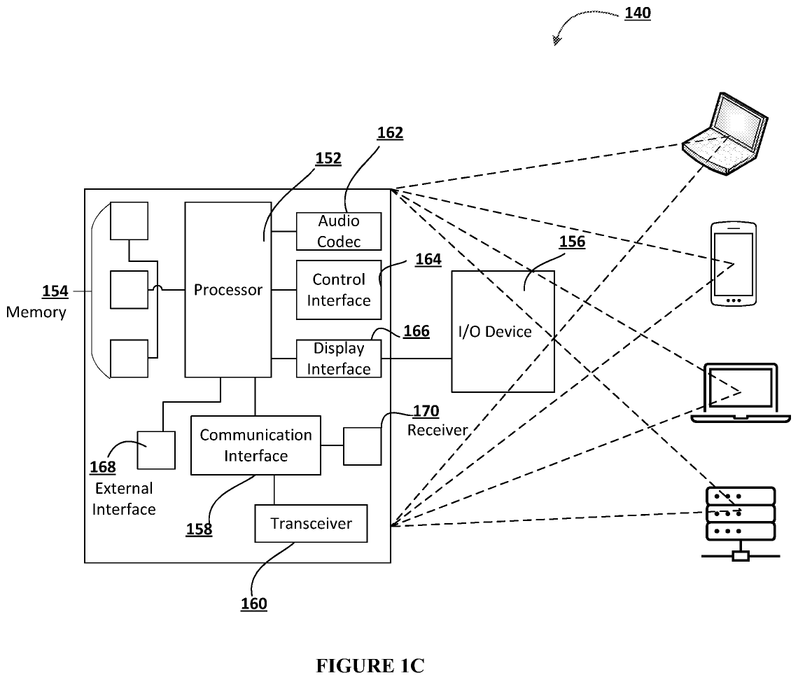

FIGS. 1A-1C illustrate technical components of an exemplary distributed computing environment for off-network remote access management platform 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

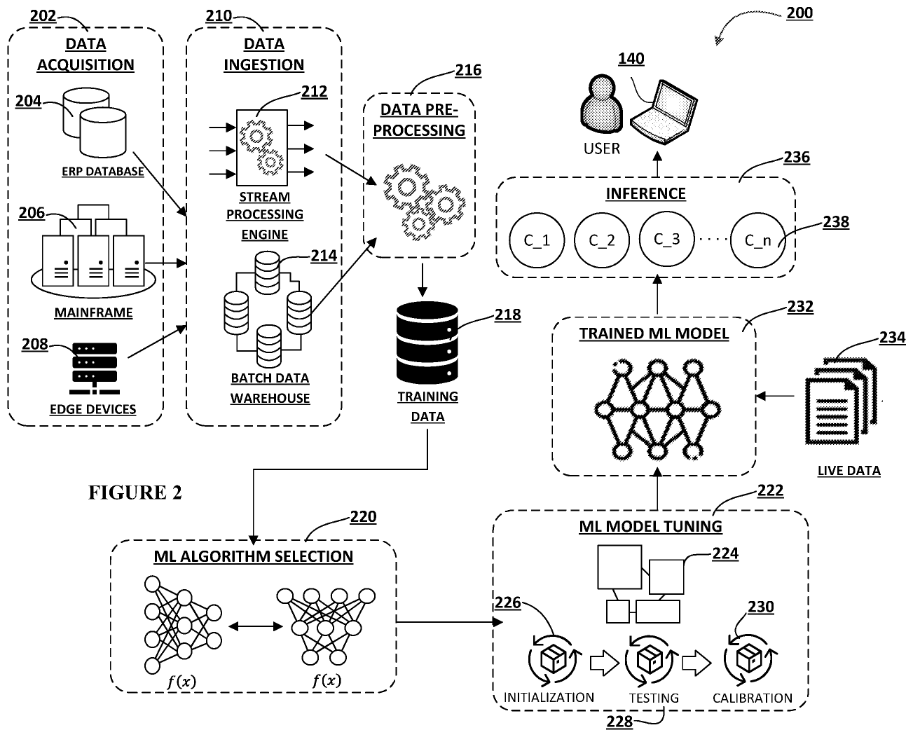

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C1, C_2 . . . C_n 238) live data 234 based on how similar they are to one another to solve exploratory challenges where little is known about the data, provide a description or label (e.g., C1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

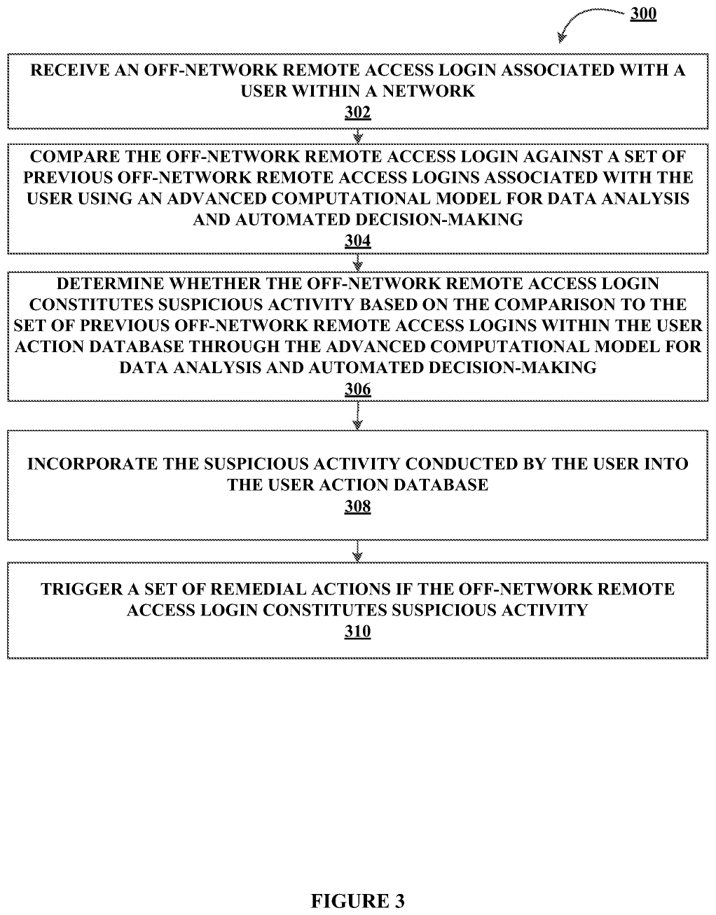

FIG. 3 illustrates a process flow 300 for systems and methods for management of off-network remote access to prevent unauthorized access to sensitive data. In some embodiments, a system and method of management of off-network remote access to prevent unauthorized access to sensitive data (e.g., similar to the one or more of the systems described herein with respect to FIGS. 1A-1C and FIG. 2) may perform one or more of the steps of process flow 300.

As shown in Block 302, the process flow 300 may include the step of receiving an off-network remote access login associated with a user within a network. The off-network remote access login may be an attempt to connect, access, and/or login by a user, individual, entity, group, and/or end-user. In other words, the off-network remote access login may be a login to a network outside of the established login procedure (i.e., remote working, working from home, logging into a network associated with an entity using an end-point device unaffiliated with the entity's network, etc.,). Remote access may further be comprised of a set of authentication credentials associated with the user and/or network entered remotely and/or off-network. Said authentication credentials may be entered within an end-point device to obtain access to the network remotely. I.e., a username and password associated with a user within the network may be entered into an off-network end point device to obtain access to the network remotely. Access to the network through an off-network remote access login attempt may be received and processed in greater detail as described below.

In some embodiments, off-network remote access may refer to the ability to access the network, the operations, and capabilities within the network remotely and/or from a device/connection originating from outside of the network. Off-network may further comprise access/connections created to perform operations, review data, and/or alter elements within the network from a source outside of the network. Off-network remote access may further refer to a physical distance, i.e., a network and the elements comprised within maybe confined within a physical space, and off-network remote access may include accessing the network outside of said physical space. For instance, if a network can be accessed within a designated office and a user attempts to access the network outside of the designated office, the attempt to access the network outside of the office may be an off-network remote access login.

In some embodiments, the off-network remote access login may be associated with a user, individual, associate, group, and/or the like which may initiate the off-network remote access login. The user may be in possession of authentication credentials used to conduct the off-network remote access login. The authentication credentials may further be used as a basis for the extent of the capabilities upon granting access to the user after the off-network remote login has been processed. For instance, the authentication credentials may be associated with a level of security within the network. Said level of security may determine the materials, capabilities, functions, and information available to the account associated with the authentication credentials. In other words, the level of security/role associated with the user may determine if functions within the network may be limited through an off-network remote access login.

In some embodiments, the received off-network remote access login may be transmitted through an off-network external source. The off-network external source may include but may not be limited to an off-network end point device, an off-network device, and/or an off-network connection used to access the network. The remote access associated with the off-network login may have restrictions, rules, limits, and/or additional security measures in place in comparison to a login processed within the network. For instance, the off-network remote access login may be able to view a set of files within the network but may not be able to alter the files as may be done if the user logged into the network without a remote connection (i.e., a remote login may constrain the capabilities of the user when compared to a non-remote login).

As shown in Block 304, the process flow 300 may include the step of comparing the off-network remote access login against a set of previous off-network remote access logins associated with the user using an advanced computational model for data analysis and automated decision-making. The set of previous logins associated with the user may be stored within a user action database. The set of previous off-network remote access logins may be previous logins attempted by the user to log into the network and may be used to analyze/determine whether the off-network remote access login attempt is outside of the realm of usual behavior associated with the user. For instance, upon reception of the off-network remote access login the login may be compared to previous logins associated with the user (i.e., the time in which the login occurred, the location from which the off-network remote access login was transmitted from, and the user associated with the off-network remote access login). If the off-network remote access login occurs at a time that deviates substantially from the routine login times/historical login times, or the login occurs on an unfamiliar device, the login may be associated with suspicious activity when compared to the set of previous logins associated with the user. In another instance, there may be predetermined hours in which the off-network remote access logins may not permitted, causing an at least partial restriction of capabilities of the user associated with the off-network remote access login (i.e., if a login occurs at an unusual time (4 am) when normal operations within the entity occur between 9 am and 5 pm then the user may not be able to access, view, and/or manipulate a set of systems). The set of previous off-network remote access logins may be stored within the user action database, which may be comprised of previous off-network remote access login attempts made by the user.

In some embodiments, comparison of the off-network remote access login to the set of previous off-network remote access logins associated with the user may be used to determine the behavior of the user and whether the login constitutes suspicious activity. Suspicious activity may be comprised of actions, attempts, logins, users, failed login attempts, deviations from established behavior/historical activity, and the like. For instance, if an off-network remote access login is detected and the user associated with the login interacts and/or accesses files outside of the known actions and files the user had interacted with before, the new interactions may be considered suspicious activity. The set of suspicious activity may be used as a basis to implement predetermined security measures including but not limited to restricting access to parts of the network, limiting capabilities, transmitting notifications to third parties associated with the network, and the like. Comparisons of the off-network remote access login may further be comprised of comparing the set of suspicious activity to previous activity found within the user action database.

In some embodiments, the user action database may be comprised of previous logins associated with the user, interactions between the user and the network, and behavior associated with the user while on the network. The user action database may be used in the comparison of the off-network remote access login to the logins within the user action database. Further, actions taken by the user after completing the off-network remote access login may be compared against previous actions performed by the user within the network. For instance, the interactions performed by the user may be recorded within the user action database, then compared against the set of user actions within the user action database for future actions. The previous logins may be used in future comparisons of the off-network remote access logins received.

As shown in Block 306, the process flow 300 may include the step of determining whether the off-network remote access login constitutes suspicious activity based on the comparison to the set of previous off-network remote access logins within the user action database through the advanced computational model for data analysis and automated decision-making. In some embodiments, the advanced computational model for data analysis and automated decision-making may be a form of machine learning, similar to the machine learning subsystem 200 described in FIG. 2. The advanced computational model for data analysis and automated decision-making may be used detect suspicious activity through the observation and training of previously detected suspicious activity found within the user action database. What constitutes suspicious activity from an off-network remote access login may include but may not be limited to repeated login attempts, an off-network remote login during unprecedented hours, an off-network remote login attempt towards systems/information/data designated for a security level access associated within the entity, and/or the like. The off-network remote access login may further be compared against the history of the user (which may be found within the user action database) to determine if the user is permitted to login remotely. For example, if a user has recently ceased association with an entity associated with the network (i.e., an employee was no longer employed by an institution) the user may have a tag, notification, mark, and/or inhibitor that prevents the off-network remote access login from logging into the network.

In some embodiments, suspicious activity may be predetermined activity, behavior, logins, unusual actions, repeated actions, requests, transmissions, messages, an off-network remote access login location from an unusual location (i.e., the location in which the off-network remote access login was transmitted from is significantly different from previous off-network remote access login attempts), and/or the like. The designation of suspicious activity may be determined through a set of predetermined criteria/rules used to define what constitutes suspicious activity. For instance, the set of suspicious activity may designate an off-network remote access login after multiple failed logins (i.e., multiple incorrect authentication credential entries in rapid succession) to constitute suspicious activity. In another instance, there may be a range of distance in which the off-network remote access login may originate from. I.e., off-network remote access logins may be permitted within a predetermined range of the entity. The set of suspicious activity may be adjusted, updated, expanded, and/or revised to include activity designated as suspicious by a third party associated with the network and/or the entity. The set of suspicious activity may further include a notification of previously detected suspicious activity For instance, if an action previously performed by the user was determined to be a suspicious action or designated as suspicious behavior, the off-network remote access login attempted by the user may trigger the transmission of a notification to the third party associated with the network, the rejection of the off-network remote access login attempt, and/or further predetermined actions associated with responding to the set of suspicious behavior. What constitutes suspicious activity may further be adjustable (i.e., criteria, rules, and/or parameters used to determine what constitute suspicious activity may be changed and/or altered).

In some embodiments, analysis of the set of suspicious activity may be achieved through comparison of the activity associated with the off-network remote access login attempt to previously catalogued actions associated with the user found within the user action database. In other words, the off-network remote access login may be compared against previous actions taken by the user. For instance, the date, time, location, and/or device used to initiate the off-network remote access login attempt may be compared to the previous date, time, location, and/or device previously associated with off-network remote access login attempts made by the user. Analysis of the set of suspicious activity may further be conducted through a search of the previous actions undertaken by the user associated with the off-network remote access login. A set of programs within the network and actions taken within said programs may further be stored and analyzed within the user action database.

In scenarios wherein a set of suspicious activity is not detected, the off-network remote access login may be accepted, and the user may access the network through the off-network remote access login. Detection of specific suspicious activity may be matched through predetermined criteria set by the third party associated with the network. In other words, suspicious activity may be set and if the user does not engage in activity that is determined to be suspicious, the user may login to the network. If suspicious activity is detected, further remedial actions may be implemented, as described in greater detail below.

As shown in Block 308, the process flow 300 may include the step of incorporating the off-network remote access login associated with the user into the user action database. Incorporation of the suspicious activity may increase the ability of the advanced computational model for data analysis and automated decision-making process and analyze future off-network remote access logins/identify suspicious activity. For example, suspicious activity such as an off-network remote access login occurring at an hour, time, location, and/or device determined to be suspicious, the data may then be stored within the user action database for future reference. The user action database may then be used by the advanced computational model for data analysis and automated decision-making to determine a set of suspicious activity (such as the machine learning subsystem 200 described in FIG. 2). Incorporation of the off-network remote access login associated with the user into the user action database may further include incorporation of the actions undertaken by the user. For instance, the actions undertaken by the user may include the off-network remote access login being initiated with authentication credentials listed as being associated with a user with a history of suspicious activity, the user may undertake activities which may restrict parts of the system while using the off-network remote access login, and/or actions performed unrelated to the actions historically taken by the user (i.e., if a user manipulates information/material belonging to another department within an entity).

As shown in Block 310, the process flow 300 may include the step of triggering a set of remedial actions if the off-network remote access login constitutes suspicious activity. The set of remedial actions may be comprised of multiple actions, measures, implementations, and the like to prevent, deter, and/or further detect suspicious activity. The set of remedial actions may be triggered after determination that the off-network remote access login constitutes suspicious activity.

In some embodiments, the set of remedial actions may include the step of transmitting a customizable alert and/or notification to a third party associated with the network if a set of suspicious activity is analyzed to occur in association with the off-network remote access login. Transmission of the notification may be comprised of an alert, message, warning, and/or the like to a third party associated with the network. In other words, a third party within the entity may receive a notification when a user attempts to login to the network using an off-network remote access login. The message may be comprised of a notification directed towards the suspicious activity associated with the off-network remote access login. For instance, the notification may indicate that suspicious activity may have been detected with the off-network remote access login and the account associated therein. The notification may further include a message indicating the suspicious activity analyzed from the off-network remote access login. For instance, the message may indicate that the login occurred from a location different from the location in which the user is normally associated with according to the user action database. In another instance, the message may indicate the suspicious activity by displaying a message to the end-point device used to transmit the off-network remote access login (i.e., if the user has initiated the login on a laptop the laptop may indicate that the login has been flagged as being suspicious). In other instances, the message may indicate the extent of the suspicious activity, such as a detailed report of the actions, requests, login attempts, or the precise actions undertaken that caused the action to be identified as a suspicious action.

In some embodiments, detection of suspicious activity may cause a set of remedial actions to counter the detected set of suspicious activities. Remedial actions may be directed towards the user, the off-network remote access login, the network, and/or the third party associated with the network to address the set of suspicious activity. Remedial actions undertaken may include but may not be limited to user based remedial actions, acknowledgements transmitted to the user and/or third party, restriction of capabilities associated with the user, transmissions of a request to the third party, denial of the off-network remote access login, analysis of the proposed login time and location, customizable notification, and/or executive level reporting on the trends and data associated with the off-network remote access login.

The third party to which the notification may be transmitted towards may be a user, entity, group, person, and/or individual associated with the network. In other words, the third party may be associated with an entity and may be used to monitor the network and off-network remote access logins. The third party may be a group used to regulate and determine the effects of the set of suspicious activity on the network within the entity. For instance, the third party may be a group within an entity that monitors and regulates the network, monitors the users within the network, and/or permits access to the users who access the network remotely (such as an off-network remote access login).

In some embodiments, the remedial actions may include the implementation of restrictions based on the user from which the off-network remote access login was transmitted. The implemented restrictions may be comprised of restrictions to the capabilities and/or actions that may be undertaken by the user after the off-network remote access login. For instance, the user may have limited access to data within the network, utilize software within the network to a predetermined limited extent, have a predetermined limited access to communications after the off-network remote access login, and/or the like. The remedial actions may further include restrictions on the information available to the user while working remotely through the off-network remote access login. Remedial actions may further be implemented based on the authentication credentials of the user. In other words, remedial actions and the limitations therein may be based off the user and their standing/position/credentials within the network. For instance, the user may have authentication credentials within the network that may enable few restrictions after logging in through the off-network remote access login. Similarly, a user with authentication credentials within the network (said authentication credentials may be a lower rank, new member associated with the entity, and the like) may encounter a greater number of restrictions if logging in with an off-network remote access login.

In some embodiments, the remedial actions may be comprised of the transmission of notifications to the user indicating that the user's actions have been identified as suspicious activity. For instance, if the off-network remote access login occurs during an unexpected hour from the normal working day (i.e., 3:00 am when the working hours are set from 9:00 am to 5:00 pm) the user may receive a notification indicating that the login was considered suspicious activity. A notification may be transmitted to the third party associated with the network in place of, or in conjunction with, the notification transmitted to the user (i.e., a notification may be transmitted to the third party in place of a notification transmitted to the user). The notification may further include a message indicating the suspicious activity to the third party.

In some embodiments, remedial actions may comprise the capabilities of the user being restricted, limited, and/or recorded. For instance, the user may not be able to view data accessible to users while on-network and may experience limited capabilities (such as restrictions on editing, altering, manipulating, revising, saving, and/or otherwise changing materials/data within the network). The limited capabilities may further be implemented through the off-network remote access login, wherein the login may indicate the status of the user and the respective capabilities that said status may enable. Capabilities limited by the off-network remote access login may be predetermined through a third party associated with the network.

In some embodiments, the set of remedial actions comprises transmission of a push notification to an end-point device to enable the off-network remote access login. The push notification may entail transmission of a first notification, receiving a response, and then permitting the off-network remote access login. For instance, an off-network remote access login may be received, causing a push notification to be transmitted to a third party or an end-point device.

In some embodiments, transmission of the of the notification may comprise notifying the third party and acknowledgement of the notification by the third party of the off-network remote access management login. Acknowledgement of the notification by the third party may include responding to the notification transmitted. Acknowledgement of the notification may further comprise reception of said acknowledgement to process the off-network remote access login. The request may be configured to transmit said acknowledgement to the user from which the off-network remote access login was originally transmitted from. In other words, the request may be a push notification, or a request that must be acknowledged by another individual before the login may proceed. The push notification may be transmitted to an end-point device associated with the origin of the off-network remote access login or the third party. The push notification may enable the user to proceed with the remote login after being acknowledged by the recipient, or a response from the recipient is received associated with the push notification.

In some embodiments, the off-network remote access login may be denied outright depending on the set of suspicious activity. For instance, the user action database may further comprise actions that if taken may bar the user from logging in through the off-network remote access login. In other instances, the off-network remote access login may be denied based on the authentication credentials. Denial of the off-network remote access login may be based on but not limited to predetermined rules violated by the user (violations may be incurred within the network or during an off-network remote access session), decisions made by the third party, and/or receiving an off-network remote access login at a time in which off-network access may be restricted.

In some embodiments, the time in which the off-network remote access login is received may be analyzed and/or factored into the remedial actions performed. The time in which the off-network remote access login is received may be recorded and compared to times in which an off-network remote access login associated with the user has historically been received within the user action database. Analysis of the time in which the off-network remote access login is received may be continuously added and expanded, as every off-network remote access login may be recorded and noted within the user action database. The times in which the logins occur may further be used to record trends associated with the user, such as when logins are likely to occur, what days the logins may occur, how frequently logins occur, and the like.

In some embodiments, the notification may be customizable by the third party. The notification may be customizable in terms of the content, the time in which the notification is transmitted, and the recipients of the notification. For instance, the notification may be customized to be transmitted to the third party and the user associated with the off-network remote access login. In another instance, the notification may be transmitted at a scheduled time (i.e., if the off-network remote access occurs at 3 am, the notification may be transmitted at 9 am the following morning). Customization of the notification may be conducted by the third party and may be adjusted by the third party accordingly.

In some embodiments, the data from the user action database may be analyzed at an executive level to examine trends and make predictions on windows when off-network remote access logins are likely to occur. For instance, the user action database may be assessed and analyzed to provide executive level summaries on trends and patterns that may provide insight into identifying suspicious activity. The executive level summary may further provide statistics and/or figures to display and analyze the data (e.g., a graph of times when off-network remote access logins occur, average times, login time distributions). In other words, the executive level summary may be an overall, high-level view of data associated with the off-network remote access login times associated with the user.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for management of off-network remote access to prevent unauthorized access to sensitive data, the system comprising:
at least one non-transitory storage device; and
at least one processing device coupled to the at least one non-transitory storage device, wherein the at least one processing device is configured to:
receive an off-network remote access login associated with a user within a network;
compare the off-network remote access login against a set of previous off-network remote access logins associated with the user using an advanced computational model for data analysis and automated decision-making,
wherein the set of previous off-network remote access logins associated with the user are stored within a user action database;
determine whether the off-network remote access login constitutes suspicious activity based on the comparison to the set of previous off-network remote access logins associated with the user within the user action database through the advanced computational model for data analysis and automated decision making;
incorporate the off-network remote access login associated with the user into the user action database; and
trigger a set of remedial actions if the off-network remote access login constitutes suspicious activity.

2. The system of claim 1, wherein suspicious activity is defined by a set of predetermined criteria within the user action database.

3. The system of claim 2, wherein the set of predetermined criteria comprises the off-network remote access login occurring during a set of predetermined hours.

4. The system of claim 1, wherein the set of remedial actions comprises transmission of a customizable notification to a third party.

5. The system of claim 1, wherein the set of remedial actions comprises transmission of a push notification to an end-point device to enable the off-network remote access login.

6. The system of claim 5, wherein the push notification is transmitted to an end-point device during a set of predetermined notification login hours.

7. The system of claim 1, wherein a set of systems within the network are restricted for off-network remote access logins constituted as suspicious activity.

8. A computer program product for management of off-network remote access to prevent unauthorized access to sensitive data, at least one non-transitory computer-readable medium having computer-readable program code portions embodied therein, the computer-readable program code portions comprising:
an executable portion configured to receive an off-network remote access login associated with a user within a network;
an executable portion configured to compare the off-network remote access login against a set of previous logins associated with the user using an advanced computational model for data analysis and automated decision-making,
wherein the set of previous off-network remote access logins associated with the user are stored within a user action database;
an executable portion configured to determine whether the off-network remote access login constitutes suspicious activity based on the comparison to the set of previous off-network remote access logins associated with the user within the user action database through the advanced computational model for data analysis and automated decision-making;
an executable portion configured to incorporate the off-network remote access login associated with the user into the user action database; and
an executable portion configured to trigger a set of remedial actions if the off-network remote access login constitutes suspicious activity.

9. The computer program product of claim 8, wherein suspicious activity is defined by a set of predetermined criteria within the user action database.

10. The computer program product of claim 9, wherein the predetermined criteria comprises the off-network remote access login occurring during a set of predetermined hours.

11. The computer program product of claim 8, wherein the set of remedial actions comprise transmission of a customizable notification to a third party.

12. The computer program product of claim 8, wherein the set of remedial actions comprises transmission of a push notification to an end-point device to enable the off-network remote access login.

13. The computer program product of claim 12, wherein the push notification is transmitted to an end-point device during a set of predetermined notification login hours.

14. The computer program product of claim 8, wherein a set of systems within the network are restricted for off-network remote access logins constituted as suspicious activity.

15. A method for management of off-network remote access to prevent unauthorized access to sensitive data, the method comprising:
receiving an off-network remote access login associated with a user within a network;
comparing the off-network remote access login against a set of previous off-network remote access logins associated with the user using an advanced computational model for data analysis and automated decision-making,
wherein the set of previous off-network remote access logins associated with the user are stored within a user action database;
determining whether the off-network remote access login constitutes suspicious activity based on the comparison to the set of previous off-network remote access logins within the user action database through the advanced computational model for data analysis and automated decision making;
incorporating the off-network remote access login associated with the user into the user action database; and
triggering a set of remedial actions if the off-network remote access login constitutes suspicious activity.

16. The method of claim 15, wherein suspicious activity is defined by a set of predetermined criteria within the user action database.

17. The method of claim 16, wherein the set of predetermined criteria comprises the off-network remote access login occurring during a set of predetermined hours.

18. The method of claim 15, wherein the set of remedial actions comprises transmission of a customizable alert to a third party.

19. The method of claim 15, wherein the set of remedial actions comprises transmission of a push notification to an end-point device to enable the off-network remote access login.

20. The method of claim 15, wherein a set of systems within the network are restricted for off-network remote access logins constituted as suspicious activity.
